(19) United States
(12) Patent Application Publication
(10) Pub. No.: US 2025/0065582 A1
(43) Pub. Date: Feb. 27, 2025

(54) Continuous-Flow Post Cure Oven

(71) Applicant: Transitions Optical, Ltd., Dunmore Road, County of Galway (IE)

(72) Inventors: Robin Evans, Bangkaew, Bang Phli District (TH); Lawrence M. Minor, Apollo Beach, FL (US); Willard Beamer, Palmetto, FL (US)

(21) Appl. No.: 18/724,854

(22) PCT Filed: Dec. 28, 2021
(86) PCT No.: PCT/EP2021/087727

§ 371 Date: Jun. 27, 2024

(51) Int. Cl. B29D 11/00

(52) U.S. Cl. CPC B29D 11/00442; B29D 11/00134

(57) ABSTRACT

An apparatus for curing at least one optical article may include a housing defining a plurality of portions configured to receive the at least one optical article, the at least one optical article being secured on a holder that moves the at least one optical article through 5 the plurality of portions, wherein the plurality of portions includes a loading portion, a heating portion, a cooling portion, and an unloading portion, and an indexable platform that is configured to sequentially move the holder and the at least one optical article from the loading portion to the heating portion, the cooling portion, and the unloading portion, wherein the holder is operatively connected to the indexable platform.

### BACKGROUND OF THE INVENTION

### Field of the Invention

The present invention relates to a thermal curing apparatus for curing a coated article. In particular, the present invention relates to a thermal curing apparatus having a plurality of portions for moving the coated article through at least a heating portion, a cooling portion, a loading portion, and an unloading portion. A method of curing a coated article using a thermal curing apparatus is also disclosed.

### Description of Related Art

With optical articles, such as lenses, one or more surfaces may be subjected to a treatment to enhance the overall performance and function of the optical articles. Examples of such treatments include the formation of one or more coatings on a surface of an optical substrate.

In order to manufacture a coated optical article from an uncoated optical substrate, a variety of manufacturing techniques have been developed. In some processes, an uncoated optical substrate is first washed and dried, after which a coating is applied on at least one surface of the substrate. With coatings that require thermal curing, the coated substrate is passed through a thermal curing device having a heating source. In large scale operations, optical substrates may be processed on an automated production line. Such a production line may have a plurality of processing stations for performing the various operations, including washing, drying, coating, and curing.

In current thermal curing devices, the optical articles are inserted into the thermal curing device in batches such that only a single group of optical articles can be cured at one time using the thermal curing device. After the optical articles have been adequately cured, the optical articles are removed from the thermal curing device and a new batch of optical articles are inserted into the thermal curing device to be cured. Due to the limitations of current thermal curing devices, a limited number of optical articles can be cured due to the limited number of optical articles that can be inserted into the thermal curing device with each batch. Therefore, there is a current need in the art for a thermal curing device that continuously moves the optical articles through the different portions of the thermal curing device, thereby increasing the number of optical articles that can be cured in a specified time period.

### SUMMARY OF THE INVENTION

In one non-limiting embodiment or aspect of the disclosure, an apparatus for curing at least one optical article may include a housing defining a plurality of portions configured to receive the at least one optical article, the at least one optical article being secured on a holder that moves the at least one optical article through the plurality of portions, wherein the plurality of portions includes a loading portion, a heating portion, a cooling portion, and an unloading portion, and an indexable platform that is configured to sequentially move the holder and the at least one optical article from the loading portion to the heating portion, the cooling portion, and the unloading portion, wherein the holder is operatively connected to the indexable platform.

In another non-limiting embodiment or aspect of the disclosure, the holder may include a carousel of holders that are configured to secure optical articles thereto to move through the plurality of portions. The carousel may move in an indexing manner to move the optical articles through the plurality of portions. The holder may include a plurality of holders that are vertically stacked on one another, wherein each holder is configured to secure the optical article thereto. Each plurality of holders may be configured to rotate freely from the remaining plurality of holders. The holder may include an optical article holding platform upon which the at least one optical article rests, wherein the optical article holding platform is configured to hold the at least one optical article as the holder moves through the plurality of portions. The apparatus may be configured to continuously move optical articles through the plurality of portions without stopping a cycle of movement of the holder through the plurality of portions to load new optical articles into the apparatus. The loading portion and the unloading portion may be configured to be accessed at the same time as the heating portion and the cooling portion are in operation. A door may be provided between the loading portion and the heating portion configured to isolate the heating portion from the loading portion, thereby permitting optical articles to be loaded onto the holder in the loading portion while the heating portion is heating a different optical article. The heating portion may define an inlet for introducing heated air from a central plenum into the heating portion to heat the at least one optical article. The heating portion may define at least one outlet in a wall of the heating portion to release the heated air from the heating portion. The at least one outlet may be configured to be adjusted on the wall of the heating portion to alter a release path of the heated air from the heating portion.

In another non-limiting embodiment or aspect, a method of curing a plurality of optical articles using a curing apparatus may include inserting a first optical article onto a first holder positioned in a loading portion of the curing apparatus; indexing the first holder, along with the first optical article, into a heating portion; inserting a second optical article onto a second holder positioned in the loading portion while the first optical article is heated in the heating portion; indexing the first holder, along with the first optical article, into a cooling portion and indexing the second holder, along with the second optical article, into the heating portion; inserting a third optical article onto a third holder positioned in the loading portion while the first optical article is cooled in the cooling portion and the second optical article is heated in the heating portion; and indexing the first holder, along with the first optical article, into an unloading portion, indexing the second holder, along with the second optical article, into the cooling portion, and indexing the third holder, along with the third optical article, into the heating portion.

In another non-limiting embodiment or aspect, the method may also include curing the first, second, and third optical articles as the first, second, and third holders are indexed through the heating portion. At least one of the first holder, the second holder, and the third holder may include a plurality of holders vertically stacked on one another and rotatable relative to one another.

The present disclosure is also identified in the following clauses:

Clause 1: An apparatus for curing at least one optical article, the apparatus comprising: a housing defining a plurality of portions configured to receive the at least one optical article, the at least one optical article being secured on a holder that moves the at least one optical article through the plurality of portions, wherein the plurality of portions includes a loading portion, a heating portion, a cooling portion, and an unloading portion, and an indexable platform that is configured to sequentially move the holder and the at least one optical article from the loading portion to the heating portion, the cooling portion, and the unloading portion, wherein the holder is operatively connected to the indexable platform.

Clause 2: The apparatus of Clause 1, wherein the holder comprises a carousel of holders that are configured to secure optical articles thereto to move through the plurality of portions.

Clause 3: The apparatus of Clause 2, wherein the carousel moves in an indexing manner to move the optical articles through the plurality of portions.

Clause 4: The apparatus of any one of Clauses 1-3, wherein the holder comprises a plurality of holders that are vertically stacked on one another, wherein each holder is configured to secure the optical article thereto.

Clause 5: The apparatus of Clause 4, wherein each plurality of holders is configured to rotate freely from the remaining plurality of holders.

Clause 6: The apparatus of any one of Clauses 1-5, wherein the holder includes an optical article holding platform upon which the at least one optical article rests, wherein the optical article holding platform is configured to hold the at least one optical article as the holder moves through the plurality of portions.

Clause 7: The apparatus of any one of Clauses 1-6, wherein the apparatus is configured to continuously move optical articles through the plurality of portions without stopping a cycle of movement of the holder through the plurality of portions to load new optical articles into the apparatus.

Clause 8: The apparatus of any one of Clauses 1-7, wherein the loading portion and the unloading portion are configured to be accessed at the same time as the heating portion and the cooling portion are in operation.

Clause 9: The apparatus of any one of Clauses 1-8, further comprising a door provided between the loading portion and the heating portion configured to isolate the heating portion from the loading portion, thereby permitting optical articles to be loaded onto the holder in the loading portion while the heating portion is heating a different optical article.

Clause 10: The apparatus of any one of Clauses 1-9, wherein the heating portion defines an inlet for introducing heated air from a central plenum into the heating portion to heat the at least one optical article.

Clause 11: The apparatus of any one of Clauses 1-10, wherein the heating portion defines at least one outlet in a wall of the heating portion to release the heated air from the heating portion.

Clause 12: The apparatus of Clause 11, wherein the at least one outlet is configured to be adjusted on the wall of the heating portion to alter a release path of the heated air from the heating portion.

Clause 13: A method of curing a plurality of optical articles using a curing apparatus, the method comprising: inserting a first optical article onto a first holder positioned in a loading portion of the curing apparatus; indexing the first holder, along with the first optical article, into a heating portion; inserting a second optical article onto a second holder positioned in the loading portion while the first optical article is heated in the heating portion; indexing the first holder, along with the first optical article, into a cooling portion and indexing the second holder, along with the second optical article, into the heating portion; inserting a third optical article onto a third holder positioned in the loading portion while the first optical article is cooled in the cooling portion and the second optical article is heated in the heating portion; and indexing the first holder, along with the first optical article, into an unloading portion, indexing the second holder, along with the second optical article, into the cooling portion, and indexing the third holder, along with the third optical article, into the heating portion.

Clause 14: The method of Clause 13, further comprising curing the first, second, and third optical articles as the first, second, and third holders are indexed through the heating portion.

Clause 15: The method of Clause 13 or Clause 14, wherein at least one of the first holder, the second holder, and the third holder comprises a plurality of holders vertically stacked on one another and rotatable relative to one another.

### BRIEF DESCRIPTION OF THE DRAWINGS

FIG. 1 is a perspective view of a thermal curing apparatus according to one non-limiting embodiment or aspect of the present disclosure.

FIG. 2 is a top view of the thermal curing apparatus of FIG. 1.

FIG. 3 is a perspective view of a heating arrangement provided in the thermal curing apparatus of FIG. 1 according to one non-limiting embodiment or aspect of the present disclosure.

### DETAILED DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

All numbers used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

The term “not greater than” is synonymous with “less than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, or C” includes A alone; or B alone; or C alone; or A and B; or A and C; or B and C; or all of A, B, and C.

The term “adjacent” means proximate to but not in direct contact with.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The term “optical” means pertaining to or associated with light and/or vision. For example, an optical element, article, or device can be chosen from ophthalmic elements, articles, and devices; display elements, articles, and devices; visors; windows; and mirrors.

The term “ophthalmic” means pertaining to or associated with the eye and vision. Non-limiting examples of ophthalmic articles or elements include corrective and non-corrective lenses, including single vision or multi-vision lenses, which may be either segmented or non-segmented multi-vision lenses (such as, but not limited to, bifocal lenses, trifocal lenses, and progressive lenses), as well as other elements used to correct, protect, or enhance (cosmetically or otherwise) vision, including without limitation, contact lenses, intra-ocular lenses, magnifying lenses, and protective lenses or visors.

As used herein, the terms “lens” and “lenses” mean and encompass at least individual lenses, lens pairs, partially formed (or semi-finished) lenses, fully formed (or finished) lenses, and lens blanks.

As used herein, the term “transparent”, such as used in connection with a substrate, film, material, and/or coating, means that the indicated substrate, film, material, and/or coating has the property of transmitting visible light without appreciable scattering so that objects lying beyond are visibly observable.

As used herein, the terms “ultraviolet”, “UV”, “ultraviolet light”, or “ultraviolet radiation” mean electromagnetic radiation having a wavelength in the range of 10 nm to 400 nm.

As used herein, the term “coating” means a supported film derived from a flowable coating material, which can optionally have a uniform thickness, and specifically excludes polymeric sheets. The terms “layer” and “film” each encompass both coatings (such as a coating layer or a coating film) and sheets, and a layer can include a combination of separate layers, including sub-layers and/or over-layers. The verb “coating” means, within appropriate context, the process of applying a coating material (or materials) to the substrate to form a coating (or coating layer).

As used herein, the terms “cure”, “cured”, and related terms, mean that at least a portion of the polymerizable and/or crosslinkable components that form a curable composition are at least partially polymerized and/or crosslinked. In accordance with some examples, the degree of crosslinking can range from 5% to 100% of complete crosslinking. In accordance with some further examples, the degree of crosslinking can range from 30% to 95%, such as 35% to 95%, or 50% to 95%, or 50% to 85% of complete crosslinking. The degree of crosslinking can range between any combination of these recited lower and upper values, inclusive of the recited values.

The discussion of the invention may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

The invention comprises, consists of, or consists essentially of the following examples of the invention, in any combination. Various examples of the invention may be discussed separately. However, it is to be understood that this is simply for ease of illustration and discussion. In the practice of the invention, one or more aspects of the invention described in one example can be combined with one or more aspects of the invention described in one or more of the other examples.

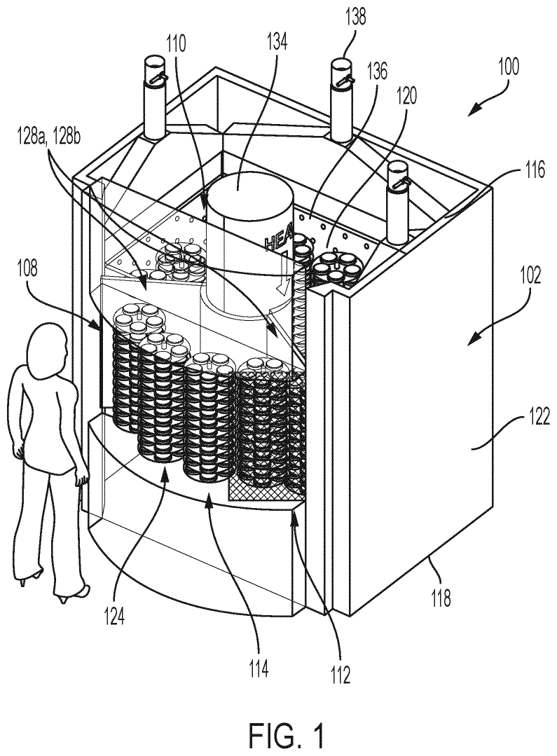

With reference to FIG. 1, a curing apparatus 100 is shown in accordance with some examples or aspects of the present disclosure. In various examples or embodiments, the curing apparatus 100 may be configured for curing a coating applied to at least one surface of an optical article. The curing apparatus 100 may be configured for emitting thermal heat for curing the coating applied to the at least one surface of the optical article. While the following disclosure describes the curing apparatus 100 configured to cure an optical article using thermal heating, one of ordinary skill in the art would readily understand that the curing apparatus 100 may be designed for curing any number of coated optical articles with ultraviolet radiation instead of thermal heating. Accordingly, the following disclosure is to be construed as exemplary only and is not intended to limit the configuration of the curing apparatus 100. It is also to be understood that the curing apparatus 100 may be used to heat articles or items other than optical articles. The curing apparatus 100 may be configured to heat any items that need to be heated or cured.

The curing apparatus 100 has a housing 102 defining a loading portion 108 that is open to ambient atmosphere, a heating portion 110 having a controlled atmosphere, a cooling portion 112 extending between the loading portion 108 and the heating portion 110, and an unloading portion 114 extending between the cooling portion 112 and the loading portion 108. The cooling portion 112 extends between the heating portion 110 and the unloading portion 114. In some examples or aspects, the loading portion 108, the heating portion 110, the cooling portion 112, and the unloading portion 114 may be defined by a common housing. In other examples or aspects, the loading portion 108, the heating portion 110, the cooling portion 112, and the unloading portion 114 may have discrete housings that are combined together end-to-end to define the overall housing 102 of the curing apparatus 100. In one embodiment or aspect, the loading portion 108 and the unloading portion 114 may be formed as single portion.

With continued reference to FIG. 1, the housing 102 has an upper portion or sidewall 116 spaced apart from a lower portion or sidewall 118. An interior 120 of the housing 102 is defined between the upper portion or sidewall 116 and the lower portion or sidewall 118, and between a pair of longitudinal portions or sidewalls 122. In some examples or aspects, the pair of longitudinal portions or sidewalls 122, the upper portion or sidewall 116, and/or the lower portion or sidewall 118 are discrete elements that are removably or non-removably connected to each other. In other examples, the pair of longitudinal portions or sidewalls 122, the upper portion or sidewall 116, and/or the lower portion or sidewall 118 may be monolithically formed with each other.

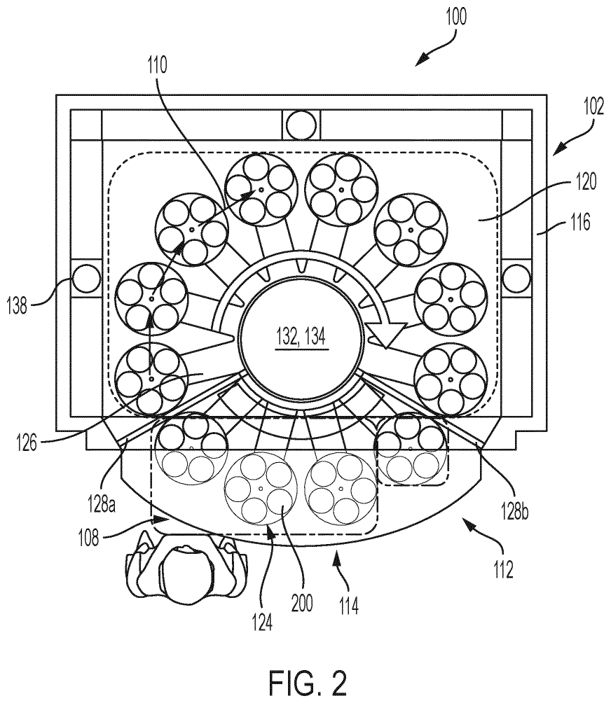

With reference to FIG. 2, the loading portion 108, the heating portion 110, the cooling portion 112, and the unloading portion 114 define separate chambers within the interior 120 of the housing 102. The loading portion 108 has at least one holder 124 configured for receiving at least one optical article 200 during loading. The loading portion 108 is open to ambient atmosphere and may be enclosed by a door. The heating portion 110 has a chamber having the controlled atmosphere for curing the optical article 200. The cooling portion 112 defines a chamber that permits the optical article 200 to cool after moving through the heating portion 110. By the time the optical article 200 has moved through the cooling portion 112, the optical article 200 will have been cooled enough such that the optical article 200 may be handled by an operator unloading the optical articles 200 from the curing apparatus 100. The unloading portion 114 and the heating portion 110 are connected to each other via the cooling portion 112.

With reference to FIG. 2, the curing apparatus 100 includes a platform 126 movable between the different portions 108, 110, 112, 114 of the curing apparatus 100. As described herein, the platform 126 is configured for supporting the at least one holder 124 that is configured to receive and retain the optical article 200 and to move the optical article 200 between the different portions 108, 110, 112, 114 of the curing apparatus 100. In some examples or aspects, the platform 126 includes a drive element (not shown), such as a motor, a linear actuator, or a rotary actuator that is operatively connected to the platform 126. The platform 126 may be operatively connected to the drive element via a belt, chain, rod, or other mechanical connection. Actuation of the drive element may be controlled by a controller, as described hereinafter, and results in movement of the platform 126. Operation of the drive element may be controlled by the controller to control the starting and stopping positions and speed at which the platform 126 moves or indexes between the different portions 108, 110, 112, 114 of the curing apparatus 100. In some embodiments or aspects, the speed at which the platform 126 moves may be different when moving from the loading portion 108 into the heating portion 110 compared to the speed when moving from the heating portion 110 to the cooling portion 112. In one embodiment or aspect, the platform 126 may be configured to move through the different portions 108, 110, 112, 114 of the curing apparatus 100 in an indexing manner. In one embodiment or aspect, an “indexing manner” is understood to be a sequential movement of the platform 126 through predetermined positions through the different portions 108, 110, 112, 114 of the curing apparatus 100. The controller may be configured such that the speed at which the platform 126 moves between the predetermined positions can be adjusted based on the desired time of heating and cooling of the optical articles 200 in the heating portion 110 and the cooling portion 112. The amount of time the optical article 200 is held in the heating portion 110 and the cooling portion 112 may depend on the composition that is being cured on the optical article 200. In another embodiment or aspect, the platform 126 may move continuously through the different portions 108, 110, 112, 114 of the curing apparatus 100. In one embodiment or aspect, the term “continuously” may be understood to mean the platform 126 does not stop while moving through the different portions 108, 110, 112, 114 of the curing apparatus 100.

The present curing apparatus 100 improves on current curing apparatuses that are multiple batch-style curing apparatuses. Due to the curing apparatus' 100 ability to continuously index product through various zones or portions—portions 108, 110, 112, 114—an operator does not need to stop the cycle of the platform 126 through the different portions 108, 110, 112, 114 of the curing apparatus 100 to load and unload new/cured optical articles 200 from the curing apparatus 100. The present curing apparatus 100 allows an operator to continuously load and unload optical articles 200 from the curing apparatus 100, unlike batch-type curing apparatuses that become inaccessible after the optical articles are loaded and the batch-type curing apparatus is initiated. Further, the curing apparatus 100 maintains a small footprint as compared to batch-type curing apparatuses that would be needed to achieve a comparable output as the curing apparatus 100. In one non-limiting embodiment of the present disclosure, the footprint of the curing apparatus 100 may be 64 inches wide, 60 inches deep, and 72 inches tall. Due to the smaller footprint of the curing apparatus 100, the curing apparatus 100 is useful in a laboratory environment.

With reference to FIG. 1, in accordance with an embodiment or aspect, the curing apparatus 100 may include doors 128a, 128b that are configured to isolate the loading portion 108 from the heating portion 110 and isolate the cooling portion 112 from the unloading portion 114, respectively. In particular, the door 128a isolates the heating portion 110, which includes a heating zone, from the ambient temperature of the loading portion 108. The door 128a also assists in protecting the operator from being hurt or burned by the heat generated in the heating portion 110. In a similar fashion, the door 128b may isolate the cooling portion 112 from the heating portion 110 so the optical articles 200 may be sufficiently cooled down before moving to the unloading portion 114 and being handled by the operator. In some embodiments or aspects, the doors 128a, 128b may be configured to automatically open and close as the platform 126 indexes the holder 124 through the different portions 108, 110, 112, 114 of the curing apparatus 100. The doors 128a, 128b may be configured to raise, lower, or slide outwardly to permit the holder 124 to pass through. In one embodiment or aspect, the doors 128a, 128b may be automatically actuated upon the holder 124 or some portion of the platform 126 tripping a sensor (not shown) to indicate that the doors 128a, 128b should be opened to permit the holder 124 to pass through. In one embodiment or aspect, the doors 128a, 128b may be opened for one index and closed between an index of the indexable movement of the platform 126.

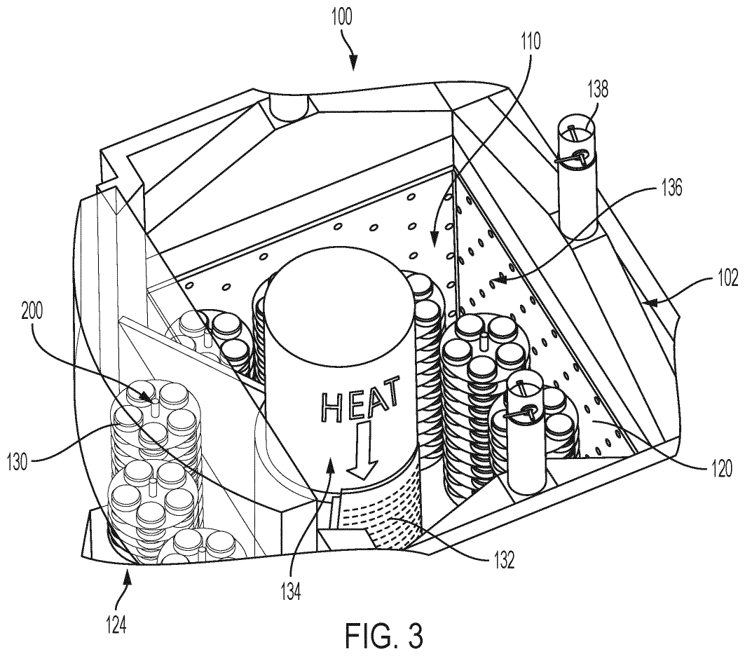

With reference to FIGS. 1 and 3, according to an embodiment or aspect, the holder 124 may be a rotatable tower including a plurality of holders 124 stacked vertically on top of one another. Each holder 124 may be configured to hold at least one optical article 200. In one embodiment or aspect, the holder 124 may hold up to five optical articles 200. It is to be understood, however, that the holder 124 may be dimensioned to hold any desired number of optical articles 200. In one embodiment or aspect, the plurality of holders 124 may include twelve holders 124. It is to be understood, however, that the number of holders 124 stacked relative to one another may be adjusted based on the desired number of optical articles 200 to be held on the holder 124. In one embodiment or aspect, the holder 124 may hold up to sixty optical articles 200. The holder 124 may be formed as a carousel configured to rotate about a vertical axis relative to the platform 126 so the operator can position the optical articles 200 on each portion of the holder 124. In the embodiment or aspect in which the holder 124 includes a plurality of holders 124, each holder 124 may be configured to rotate about a vertical axis relative to the platform 126 and relative to the remaining holders 124. In one embodiment of the present disclosure, the holders 124 are only configured to rotate about the vertical axis when the holders 124 are in either the loading portion 108 or the unloading portion 114, but remain locked from rotation when in the heating portion 110 and the cooling portion 112. The holders 124 may be manually rotated by an operator or may be rotated using a controller (not shown).

In accordance with an embodiment or aspect, the holder 124 may also include an optical article holding platform 130 used to hold the optical article(s) 200 as the optical article(s) 200 are moved through the heating portion 110. The optical article holding platform 130 may be operatively connected to the surface of the holder 124 upon which the optical article(s) 200 rests or may be formed integral with the surface of the holder 124 upon which the optical article(s) 200 rests.

As shown in FIG. 3, in accordance with an embodiment or aspect, the heating portion 110 may include at least one inlet 132 for introducing heated air into the heating portion 110 to cure the optical article(s) 200 moving through the heating portion 110. In one embodiment or aspect, the at least one inlet 132 may be a plurality of inlets that direct heated air into the heating portion 110. The inlet 132 may be defined in a central plenum 134 that extends vertically through a center of the curing apparatus 100. The central plenum 134 may receive the heated air from a separate source (not shown) and direct the heated air into the heating portion 110 through the inlet 132. In one embodiment or aspect, the inlet 132 is configured to direct the heated air through the optical article holder(s) 124 to heat the optical article(s) 200 held on the holder(s) 124. The heated air circulates through the heating portion 110 to heat the optical article(s) 200.

In accordance with one embodiment or aspect, the sidewalls 122 may define a plurality of outlets 136 configured to direct the heated air out of the heating portion 110. The outlets 136 may be defined in the sidewalls of the curing apparatus 100 and act as exhaust plenums 138 for the heated air. The outlets 136 may be provided across the entire surface of the sidewalls of the curing apparatus 100. In one embodiment or aspect, the position of the outlets 136 may be adjusted to change the flow path of the heated air through the heating portion 110. In one example, the outlets 136 may be opened and closed according to the operator's desire. By choosing which outlets 136 to open and close, the operator can adjust where the heated air is exhausted from the heating portion 110, thereby adjusting the flow path of the heated air from the inlet 132 to the outlet 136. In one non-limiting embodiment or aspect, the open area of the outlets 136 may be increased or decreased to adjust the amount of heated air that is removed through the sidewalls 122 of the curing apparatus 100. In one embodiment or aspect, the heated air is directed from the outlet 136 to at least one exhaust plenum 138 that directs the heated air out of the curing apparatus 100. At least three exhaust plenums 138 may be provided in the curing apparatus 100 to exhaust heated air from each sidewall of the heating portion 110.

The present invention has been described with reference to specific details of particular examples thereof. It is not intended that such details be regarded as limitations upon the scope of the invention except insofar as and to the extent that they are included in the accompanying claims.

1. An apparatus for curing at least one optical article, the apparatus comprising:
a housing defining a plurality of portions configured to receive the at least one optical article, the at least one optical article being secured on a holder that moves the at least one optical article through the plurality of portions, wherein the plurality of portions includes a loading portion, a heating portion, a cooling portion, and an unloading portion, and
an indexable platform that is configured to sequentially move the holder and the at least one optical article from the loading portion to the heating portion, the cooling portion, and the unloading portion, wherein the holder is operatively connected to the indexable platform.

2. The apparatus of claim 1, wherein the holder comprises a carousel of holders that are configured to secure optical articles thereto to move through the plurality of portions.

3. The apparatus of claim 2, wherein the carousel moves in an indexing manner to move the optical articles through the plurality of portions.

4. The apparatus of claim 1, wherein the holder comprises a plurality of holders that are vertically stacked on one another, wherein each holder is configured to secure the optical article thereto.

5. The apparatus of claim 4, wherein each plurality of holders is configured to rotate freely from the remaining plurality of holders.

6. The apparatus of claim 1, wherein the holder includes an optical article holding platform upon which the at least one optical article rests, wherein the optical article holding platform is configured to hold the at least one optical article as the holder moves through the plurality of portions.

7. The apparatus of claim 1, wherein the apparatus is configured to continuously move optical articles through the plurality of portions without stopping a cycle of movement of the holder through the plurality of portions to load new optical articles into the apparatus.

8. The apparatus of claim 1, wherein the loading portion and the unloading portion are configured to be accessed at the same time as the heating portion and the cooling portion are in operation.

9. The apparatus of claim 1, further comprising a door provided between the loading portion and the heating portion configured to isolate the heating portion from the loading portion, thereby permitting optical articles to be loaded onto the holder in the loading portion while the heating portion is heating a different optical article.

10. The apparatus of claim 1, wherein the heating portion defines an inlet for introducing heated air from a central plenum into the heating portion to heat the at least one optical article.

11. The apparatus of claim 1, wherein the heating portion defines at least one outlet in a wall of the heating portion to release the heated air from the heating portion.

12. The apparatus of claim 1, wherein the at least one outlet is configured to be adjusted on the wall of the heating portion to alter a release path of the heated air from the heating portion.

13. A method of curing a plurality of optical articles using a curing apparatus, the method comprising:
inserting a first optical article onto a first holder positioned in a loading portion of the curing apparatus;
indexing the first holder, along with the first optical article, into a heating portion;
inserting a second optical article onto a second holder positioned in the loading portion while the first optical article is heated in the heating portion;
indexing the first holder, along with the first optical article, into a cooling portion and indexing the second holder, along with the second optical article, into the heating portion;
inserting a third optical article onto a third holder positioned in the loading portion while the first optical article is cooled in the cooling portion and the second optical article is heated in the heating portion; and
indexing the first holder, along with the first optical article, into an unloading portion, indexing the second holder, along with the second optical article, into the cooling portion, and indexing the third holder, along with the third optical article, into the heating portion.

14. The method of claim 13, further comprising curing the first, second, and third optical articles as the first, second, and third holders are indexed through the heating portion.

15. The method of claim 13, wherein at least one of the first holder, the second holder, and the third holder comprises a plurality of holders vertically stacked on one another and rotatable relative to one another.
